(19) United States
(12) Patent Application Publication
(10) Pub. No.: US 2019/0325064 A1
(43) Pub. Date: Oct. 24, 2019

(54) CONTEXTUAL AGGREGATION OF COMMUNICATIONS WITHIN AN APPLICANT TRACKING SYSTEM

(71) Applicant: Microsoft Technology Licensing, LLC, Redmond, WA (US)

(72) Inventors: Christian V. Mathiesen, Mountain View, CA (US); Wai Lim W. Pong, San Jose, CA (US); Shen Shen, San Jose, CA (US)

(73) Assignee: Microsoft Technology Licensing, LLC, Redmond, WA (US)

(21) Appl. No.: 15/961,622

(22) Filed: Apr. 24, 2018

(51) Int. Cl. G06F 17/30; G06Q 10/10

(52) U.S. Cl. CPC G06F 17/30705; G06Q 10/1053; G06F 17/30867; G06F 17/30528; G06F 17/30702

(57) ABSTRACT

The disclosed embodiments provide a system for processing data. During operation, the system obtains, from multiple platforms, a set of communications between recruiters and applicants. Next, the system automatically identifies a recruiting context from one or more attributes of a first communication in the set of communications, wherein the recruiting context includes an applicant associated with an opportunity. The system also stores an association between the recruiting context and the first communication. The system then aggregates the first communication with additional communications associated with the recruiting context. Finally, the system displays the aggregated communications within a user interface that is separate from a platform used to transmit the first communication.

### BACKGROUND

### Field

The disclosed embodiments relate to applicant tracking systems. More specifically, the disclosed embodiments relate to techniques for performing contextual aggregation of communications within an applicant tracking system.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online professional networks may facilitate other types of activities and operations. For example, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be generated, queried, updated, and/or accessed through the online professional networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows an exemplary screenshot in accordance with the disclosed embodiments.

FIG. 4 shows a flowchart illustrating the processing of data in accordance with the disclosed embodiments.

FIG. 5 shows a flowchart illustrating a process of automatically identifying a recruiting context from an attribute of a communication in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

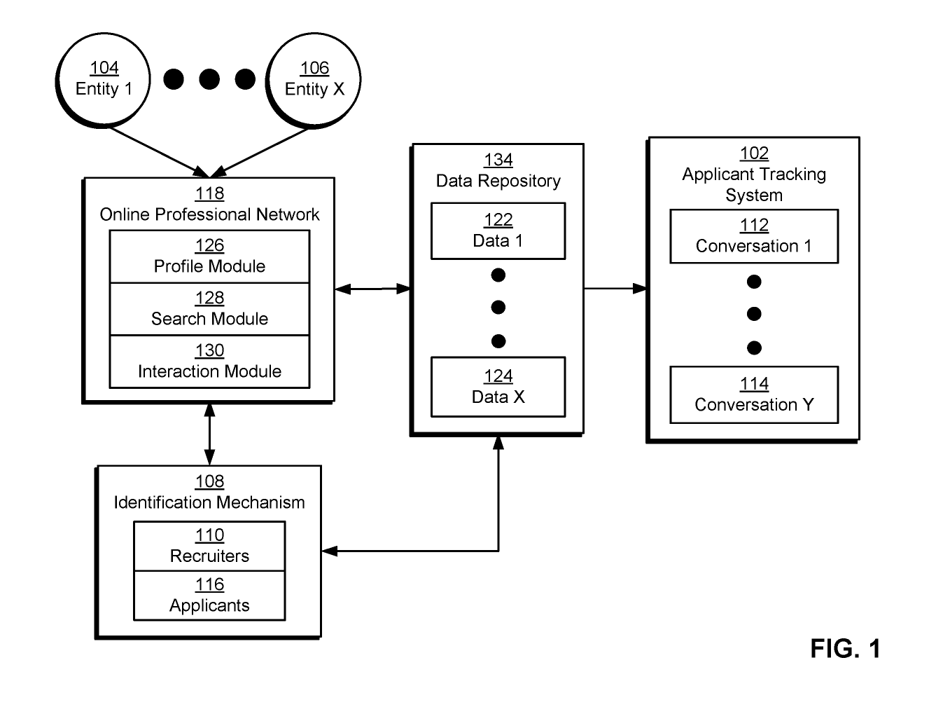

The disclosed embodiments provide a method, apparatus, and system for performing contextual aggregation of communications within an applicant tracking system. As shown in FIG. 1, an applicant tracking system 102 may be used with an online professional network 118 and/or another community of users that allows a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

In turn, member profiles and/or activity with online professional network 118 are used by or with an applicant tracking system 102 to guide and/or improve decisions and actions by recruiters 110, hiring managers, human resources professionals, and/or other “moderators” involved in hiring and/or recruiting. Applicant tracking system 102 may allow the moderators to manage, schedule, and/or track phone screens, onsite interviews, auditions, and/or other types of interviews or interaction related to screening applicants 116 for jobs, positions, roles, and/or opportunities. Applicant tracking system 102 may also allow the moderators to monitor the availability of applicants 116 for new opportunities, manage resumes and/or applicant profiles, search for and/or filter applicants 116 for the opportunities, and/or connect or communicate with applicants 116 via built-in and/or external messaging mechanisms.

Applicant tracking system 102 may be provided by and/or accessed through online professional network 118. For example, applicant tracking system 102 may form a part of a recruiting product and/or tool offered by or through online professional network 118. As a result, applicant tracking system 102 may integrate with other features of online professional network 118, such as profile module 126, search module 128, and/or interaction module 130. Recruiters 110 and/or other moderators may use the features to search for applicants 116 with qualifications for certain opportunities, view professional profiles and/or resumes of applicants 116, send and receive messages with applicants 116, track the applicants' interest in opportunities, and/or otherwise supplement activities and/or interactions related to hiring and recruiting.

Applicant tracking system 102 may also, or instead, be used and/or implemented separately from online professional network 118. For example, applicant tracking system 102 may be provided by a standalone application and/or service. In turn, applicant tracking system 102 may access some or all data and/or features available on online professional network 118 through one or more application-programming interfaces (APIs) and/or other communications mechanisms with online professional network 118.

As shown in FIG. 1, an identification mechanism 108 identifies recruiters 110 and applicants 116 associated with applicant tracking system 102. First, identification mechanism 108 may identify applicants 116 as users who have applied to jobs, positions, roles, and/or opportunities, within or outside online professional network 118. Identification mechanism 108 may also, or instead, identify applicants 116 as users and/or members of online professional network 118 with skills, work experience, and/or other attributes or qualifications that match the corresponding jobs, positions, roles, and/or opportunities.

Second, identification mechanism 108 may identify recruiters 110 as members of online professional network 118 and/or other users who have paid and/or registered accounts with applicant tracking system 102 and/or a recruiting tool provided by or through online professional network 118. Recruiters 110 may also, or instead, include users that are identified by identification mechanism 108 as having skills, experience, job titles, industries, and/or other qualifications for performing hiring and/or recruiting.

Identification mechanism 108 and/or another component of the system may also include functionality to obtain user input for specifying recruiters 110, applicants 116, and/or other entities involved in placing and/or applying for opportunities. For example, the component may include a user interface that allows a recruiter, sourcer, hiring manager, human resources professional, and/or other moderator involved in screening for and/or placing jobs, positions, roles, and/or opportunities to associate one or more applicants 116 and/or recruiters 110 with job requisitions managed through applicant tracking system 102.

In one or more embodiments, applicant tracking system 102 includes functionality to perform contextual aggregation of conversations (e.g., conversation 1 112, conversation y 114) related to hiring and/or recruiting activities that are managed using applicant tracking system 102. Such conversations may include emails, chat messages, phone calls, voicemails, video calls, teleconferences, social media messages, Short Message Service (SMS) messages, and/or other types of communications that are conducted and/or hosted using multiple platforms. After the conversations are imported from the platforms, applicant tracking system 102 may display the aggregated conversations to provide a centralized view of recent and/or historical interaction between recruiters 110 and applicants 116. As a result, applicant tracking system 102 may consolidate and provide important information that can be shared and/or maintained across recruiters 110 and/or used by recruiters 110 to make decisions related to recruiting, screening, placing, and/or hiring applicants 116.

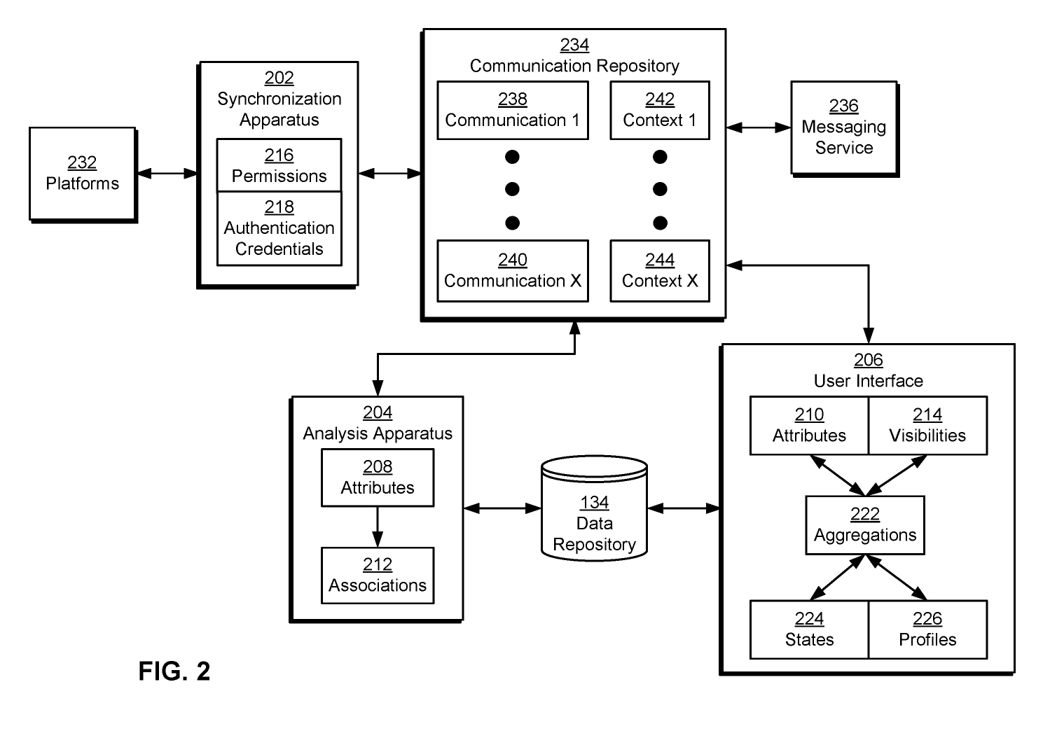

FIG. 2 shows a system for processing data in accordance with the disclosed embodiments. More specifically, FIG. 2 shows a system for aggregating communications within a recruiting tool such as an applicant tracking system (e.g., applicant tracking system 102 of FIG. 1). The system includes a synchronization apparatus 202, an analysis apparatus 204, and a user interface 206. Each of these components is described in further detail below.

Synchronization apparatus 202 obtains a set of communications (e.g., communication 1 238, communication x 240) from a number of platforms 232 such as mail servers, cellular networks, videoconferencing systems, chat programs, and/or social media services. Prior to obtaining the communications, synchronization apparatus 202 may obtain permissions 216 and authentication credentials 218 for accessing user accounts on platforms 232. Synchronization apparatus 202 may then use authentication credentials 218 to access the user accounts and copy communications and/or records of the communications from the user accounts to a communication repository 234.

For example, synchronization apparatus 202 and/or another component of the system may obtain permission (e.g., permissions 216) from a recruiter and/or other user to synchronize an external email address (e.g., a work email address) with the recruiting tool. The permission may be obtained via a request that is displayed to the user, from user settings related to the user's account with the recruiting tool, and/or using another mechanism. The component may also allow the user to disable synchronization of his/her external email address with the recruiting tool and/or delete some or all synchronized emails from the external email address on the recruiting tool.

After the user grants permission to synchronize the external email address with the recruiting tool, the component may obtain authentication credentials 218 such as a username and password, biometric identifier, digital certificate, security token, public key, personal identification number (PIN), knowledge-based authentication factor, and/or pattern factor for accessing the external email address from the user. In turn, synchronization apparatus 202 may use the provided authentication credentials 218 to access the email account (e.g., through an API with the mail server and/or email service) and retrieve recent, unsynchronized emails from the email account. Synchronization apparatus 202 may also store the emails in a database, distributed filesystem, data warehouse, collection of files, cloud storage, and/or other data store providing communication repository 234. Such synchronization of emails with communication repository 234 may be repeated periodically (e.g., every five minutes, every 15 minutes, every 30 minutes, hourly, etc.), based on a trigger from the user (e.g., a request to synchronize email with the applicant tracking system), and/or based on a trigger from the email account (e.g., via a push notification of new emails from the email account).

In another example, the user may grant permission to synchronize phone calls, voicemails, and/or SMS messages with the recruiting tool. Synchronization apparatus 202 may use an application on the user's phone and/or an API with a cellular provider to copy the SMS messages, call logs (e.g., call times, call durations, phone numbers, etc.), and/or recordings or transcripts of the calls and/or voicemails to communication repository 234.

In a third example, communications may be obtained from a messaging service 236 provided by a social network, online professional network (e.g., online professional network 118 of FIG. 1), and/or other online community that provides and/or is linked to the recruiting tool. As a result, permissions 216 may be managed through privacy and/or user settings with the online community and/or the recruiting tool, and communications transmitted within the online community may automatically be imported from the online community into communication repository 234.

When communications from one or more external platforms 232 are synchronized into communication repository 234, analysis apparatus 204 uses attributes 208 of communications in communication repository 234 to identify contexts (e.g., context 1 242, context x 244) associated with the communications. Each context may identify a specific workflow and/or type of usage of the applicant tracking system. For example, each communication in communication repository 234 may be associated with a context that includes an account for accessing the recruiting tool (e.g., a subscription account with the recruiting tool), as well as a “hire identity” representing an applicant that is managed using the recruiting tool. In other words, the context may include, at a minimum, identities of entities that use the communication as a part of recruiting or hiring activities.

In turn, attributes 208 of a communication may include information that can be matched to profile data and/or other personally identifiable information (PII) for a user (e.g., recruiter and/or applicant) in data repository 134. For example, analysis apparatus 204 may obtain, from an email header of an email, attributes 208 that include email addresses for a sender and recipient of the email. Analysis apparatus 204 may match one or both email addresses to email address fields in profile data from data repository 134 to identify an applicant as the sender or recipient of the email. The profile data may be obtained from a member profile of the applicant with a social network or online professional network, or the profile data may be maintained in data repository 134 separately from any member profiles of the applicant. Analysis apparatus 204 may then generate the context of the email with identities of the sender and/or recipient, which may include the applicant and/or one or more recruiters. Analysis apparatus 204 may also, or instead, update the context with the account for which the email was synchronized, such as a subscription account that enables access to the recruiting tool by the recruiter(s).

In one or more embodiments, the system of FIG. 2 includes functionality to automatically identify contexts associated with communications from multiple platforms 232, even when attributes 208 of the communications are not explicitly listed in publicly available profiles of the respective users. Such explicitly listed attributes 208 may include phone numbers, email addresses, mailing addresses, and/or other contact information in member profiles and/or listings from a social network, online professional network, and/or public directory.

Instead, analysis apparatus 204 and/or another component of the system may extract the contact information from messages transmitted between the applicant and a recruiter within messaging service 236 in a social network and/or online professional network. For example, the recruiter may find the applicant in job candidate search results on an online professional network providing the recruiting tool. Next, the recruiter may establish initial contact with the applicant by sending a message to the applicant using messaging service 236 provided by the online professional network. After the applicant expresses interest in an opportunity managed by the recruiter, the recruiter may request a phone number and/or email address from the applicant. Once the applicant provides his/her phone number and/or email address in a follow-up message, the component may obtain the phone number and/or email address from the message and associate the phone number and/or email address with the applicant's profile with the online professional network. If the contact information provided through messaging service 236 differs from any contact information listed in the applicant's profile data, the component may store both versions of the contact information in the profile data and/or maintain each version in a separate contact record and/or field for the applicant.

The component may additionally use other sources of information to obtain information that can be used to establish a context of a communication. For example, the component may obtain phone numbers, email addresses, mailing addresses, and/or other PII for an applicant and/or other user from public records. When new or additional contact information for an applicant is found, the component may create and/or update a contact record for the applicant and/or the applicant's hire identity in the recruiting tool.

Consequently, additional contact information obtained outside of explicit profile attributes and/or public listings may increase the likelihood of establishing a recruiting context from an imported communication. For example, an email address provided by an applicant in a message that is transmitted within an online professional network may subsequently be matched to the sender or recipient of an email that is imported into communication repository 234. In contrast, the applicant's identity may fail to be established from the email if the message was not parsed or analyzed to obtain the applicant's email address.

Analysis apparatus 204 may optionally use other attributes 208 of communications imported into communication repository 234 to verify contexts associated with the communications. For example, analysis apparatus 204 may further verify a recruiting context in a communication by analyzing the communication for keywords related to recruiting or hiring, such as “opportunity,” “position,” “role,” “company,” “professional,” “hire,” “salary,” “benefits,” “title,” “job,” “requirements,” “candidate,” “experience,” “placement,” “interview,” and/or “recruit.”

Once analysis apparatus 204 establishes a recruiting context for a communication in communication repository 234, analysis apparatus 204 stores an association (e.g., associations 212) between the communication and the context in communication repository 234 and/or another data store. First, analysis apparatus 204 and/or another component of the system may maintain a record of each context that includes identifiers for an account used to access the recruiting tool, one or more recruiters, and/or an applicant. When analysis apparatus 204 identifies a new context in a communication (e.g., a first communication between the account used to access the recruiting tool and a new applicant), analysis apparatus 204 may create a record and/or representation of the new context in the data store.

When a recruiting context is identified from one or more attributes 208 of a communication, analysis apparatus 204 may store a record containing an association of the communication with the context in the data store. For example, analysis apparatus 204 may store the record in a table representing the context (e.g., a table that is linked to a record for the context and/or a table that includes one or more fields of the context). The record may include fields such as a job requisition associated with the communication, an identifier for a recruiter participating in the communication (e.g., as a sender or recipient of an email or message, a participant in a phone call or teleconference, etc.), and/or a timestamp representing the time of the communication. The record may also include a hashed value of the communication and/or a thread containing the communication, along with encrypted and/or unencrypted contents or references to fields in the communication (e.g., subject, body, sender, and/or recipient of an email; phone numbers in an SMS and/or phone call; usernames and/or names involved in video conference). The hashed value may be used to deduplicate communications that involve multiple members of the same recruiting team associated with a given account.

On the other hand, analysis apparatus 204 may fail to identify a recruiting context for some communications in communication repository 234. For example, analysis apparatus 204 may fail to match a communication to a recruiting context when no known applicants are found among the participants in the communication. As a result, analysis apparatus 204 and/or another component of the system may delete the communication from communication repository 234 and/or flag the communication as deleted and/or irrelevant to hiring or recruiting. Instead, a recruiter may manually establish a recruiting context for the communication by identifying the applicant in the communication and/or creating a hire identity for the applicant.

After communications in communication repository 234 are updated with recruiting contexts and/or identified as lacking recruiting contexts, user interface 206 uses the communications to provide a centralized view of recent and/or historical interaction between recruiters and applicants. In particular, user interface 206 displays aggregations 222 of communications from communication repository 234 that are associated with recruiting contexts.

First, user interface 206 may display aggregations 222 as a list and/or other representation of communications between recruiters and applicants. The list may include representations of communications between one or more recruiters that use an account or subscription with the recruiting tool and a set of applicants engaged by the recruiters. As a result, a new recruiter that has taken over a requisition can use communications in the list to obtain information related to the status of the requisition and/or applicants in the recruiting pipeline for the requisition. The list may also, or instead, allow the recruiters to identify when an applicant has been contacted by more than one recruiter and facilitate subsequent merging of communication with the applicant to a single recruiter or point of contact.

Conversely, communications may be hidden and/or removed from aggregations 222 based on visibilities 214 associated with the communications. For example, communications synchronized into communication repository 234 may have visibility settings of “private,” “hiring project,” and “account.” A visibility setting of “private” restricts display of a communication to recruiters participating in the communication and/or the user that imports the communication into the recruiting tool. A visibility setting of “hiring project” restricts display of the communication to recruiters that are assigned to a specific job requisition. A visibility setting of “account” restricts display of the communication to the account and/or subscription with the recruiting tool, which may represent a recruiting agency and/or company. Finally, a communication that has been deleted from the recruiting tool may be hidden from all users of the recruiting tool, even if a record of the communication is still found in communication repository 234.

When a communication is imported into the system, the communication may be associated with a default visibility such as “private.” A recruiter participating in the communication may change the visibility to surface the communication to other recruiters on the same hiring project and/or company, or the recruiter may delete the email to remove all access to the email from the recruiting tool. The recruiter may also, or instead, change the default visibility of communications imported from the recruiter's external accounts (e.g., email addresses, phone numbers, chat handles, social media usernames, etc.) to a less restrictive setting and/or disable synchronization of communications from one or more external accounts.

Second, user interface 206 may store, group, organize, filter, and/or otherwise modify aggregations 222 based on attributes 210 associated with the communications. For example, emails, messages, and/or other communications that share the same subject, recruiter, applicant, hiring project, communication type (e.g., email, SMS, chat, social media, phone, teleconference, social media, etc.), and/or context may be grouped under a thread, conversation, and/or “category” within user interface 206. The grouped communications may be shown with attributes 210 such as subject, participants, communication type, date, and/or date range (e.g., the range of dates encompassed by the communications). Multiple threads, conversations, and/or categories may also be sorted and/or organized within user interface 206 by the same attributes and/or different attributes (e.g., the date of the most recent conversation in a thread, conversation, or category). A user may click on a header for a group of conversations to expand the header into a list of communications and/or records of communications related to the group.

In another example, communications, threads, conversations, and/or categories displayed under aggregations 222 may be filtered by attributes 210 such as applicant, recruiter, requisition, date, requisition status (e.g., open, closed, filled, cancelled, frozen, etc.), requisition fields (e.g., employer, industry, position, summary, job description, location, skills, requirements, salary, benefits, etc.), and/or communication type. In a third example, multiple communications that generate the same hash value (e.g., the same communication involving multiple recruiters) may be deduplicated within aggregations 222 to avoid unnecessary and/or undesired repetition of the same content within user interface 206.

Third, user interface 206 may display aggregations 222 with additional data that facilitates activities or decisions related to hiring or recruiting. In particular, user interface 206 may display and/or modify aggregations 222 based on states 224 represented by the communications. For example, states 224 may include an applicant's apparent or perceived interest or lack of interest in an opportunity, based on the sentiment or content of the applicant's response to a recruiter about the opportunity. As a result, a thread related to the opportunity may include an indication of the applicant's apparent interest or lack of interest in the opportunity at a point at which the interest or lack of interest was received or established. In another example, states 224 may include confirmation of a phone screen, interview, onsite visit, and/or other event related to hiring or recruiting of the applicant. Alternatively, states 224 may include a scheduling conflict the applicant has with the event. In turn, the appearance of a message thread related to scheduling of the event may be modified (e.g., using highlighting, coloring, shading, font styling, etc.) to reflect the confirmation or conflict.

User interface 206 may also, or instead, display aggregations 222 with profiles 226 of the respective applicants. For example, a recruiting profile of an applicant may be displayed within an overlay, pop-up, and/or other user-interface element when a cursor is placed over a communication or thread involving the applicant. The recruiting profile may include fields and/or information such as the applicant's name, photo, location, industry, title, skills, recommendations, endorsements, work experience, accomplishments, educational background, contact information, and/or resume. In another example, one or more aggregations 222 of communications involving an applicant may be displayed within a page or screen containing the recruiting profile of the applicant.

By aggregating communications from multiple platforms 232 and showing the communications within a recruiting and/or hiring context, the system of FIG. 2 may centralize and/or organize information that is used to conduct recruiting and/or hiring activities. In turn, recruiters and/or other moderators involved in recruiting or hiring may use the information to improve subsequent communication with applicants and/or guide decisions or actions related to recruiting or hiring. Consequently, the system of FIG. 2 may improve applications and computer technologies related to recruiting, communication, and/or online networks, as well as user engagement, user experiences, and user interaction through the applications and technologies and/or network-enabled devices used to access the applications and technologies.

Those skilled in the art will appreciate that the system of FIG. 2 may be implemented in a variety of ways. First, synchronization apparatus 202, analysis apparatus 204, user interface 206, data repository 134, and communication repository 234 may be provided by a single physical machine, multiple computer systems, one or more virtual machines, a grid, one or more databases, one or more filesystems, and/or a cloud computing system. Synchronization apparatus 202, analysis apparatus 204, and user interface 206 may additionally be implemented together and/or separately by one or more hardware and/or software components and/or layers.

Second, communications, permissions 216, authentication credentials 218, contexts, profiles 226, and/or other data used by the system may be stored, defined, and/or transmitted using a number of techniques. As mentioned above, the system may be configured to aggregate and/or analyze various types of communications and/or metadata related to the communications, such as emails, SMS messages, chat messages, social media messages, voicemails, and/or records or transcripts of phone calls, teleconferences, and/or videoconferences. Similarly, the system may store the communications and/or related data in a number of formats, including database records, property lists, Extensible Markup language (XML) documents, JavaScript Object Notation (JSON) objects, and/or other types of structured data.

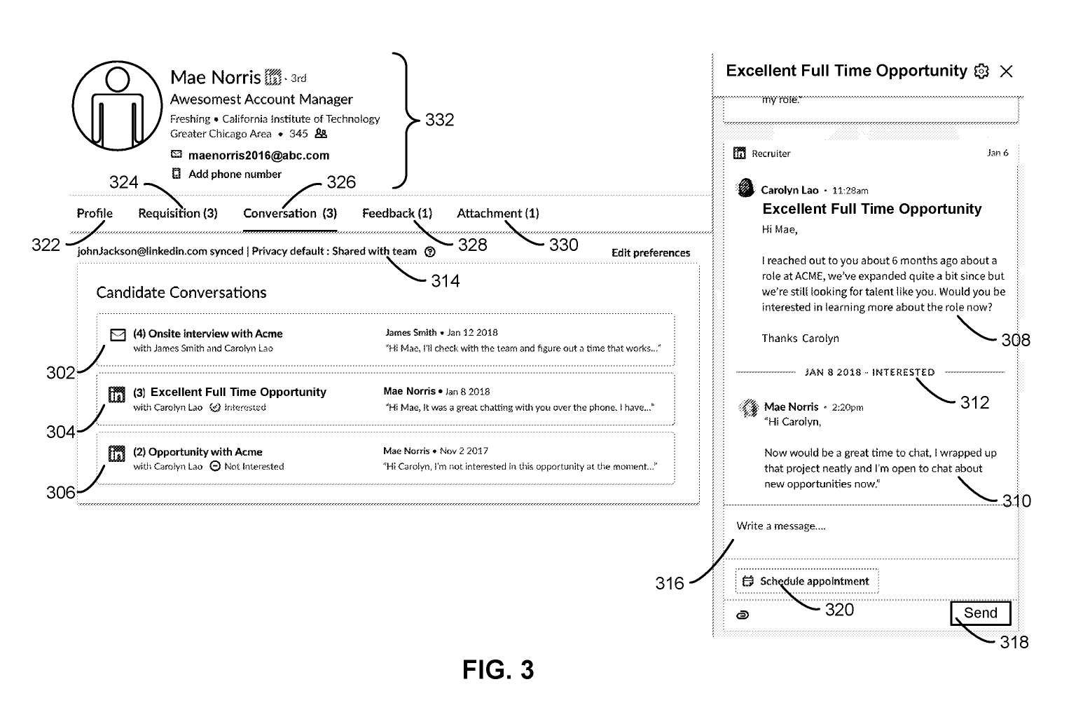

FIG. 3 shows an exemplary screenshot in accordance with the disclosed embodiments. In particular, FIG. 3 shows a screenshot of a user interface for a recruiting tool, such as user interface 206 of FIG. 2. As mentioned above, the user interface may aggregate communications associated with a recruiting and/or hiring context from multiple platforms.

As shown in FIG. 3, the user interface includes a “candidate conversations” module containing three user-interface elements 302-306. User-interface elements 302-306 may represent threads of communications involving an applicant (i.e., “Mae Norris”) that is managed using the recruiting tool.

User-interface elements 302-306 may be generated and/or displayed based on permissions and/or visibility settings associated with a user of the recruiting tool, which are shown in a user-interface element 314. In particular, user-interface element 314 indicates that an email address named “johnJackson@linkedn.com” is synchronized with the recruiting tool, and that the default privacy of communications synchronized from the email address is set to the user's team. Within the user interface, a communication or thread may be displayed to the user when the communication or thread is set to be visible to the user.

User-interface elements 302-306 include information related to messages and/or communications within the corresponding threads. First, the attributes include a graphic representing a communication type used with each thread. For example, an envelope graphic in user-interface element 302 may indicate that the corresponding thread contains email communications, and an “in” graphic in user-interface elements 304-306 may indicate that the corresponding threads contain communications from a messaging service provided by an online professional network.

Second, the attributes specify a number of communications in each thread. For example, numbers next to the graphics in user-interface elements 302-306 indicate that the threads contain four emails, three messages, and two messages, respectively.

Third, the attributes may include subjects of the threads and identify non-applicant participants in communications within the threads. For example, user-interface element 302 identifies a subject of “Onsite Interview with Acme” and participants of “James Smith” and “Carolyn Lao” for emails in the corresponding thread. User-interface element 304 identifies a subject of “Excellent Full Time Opportunity” and a participant of “Carolyn Lao” for messages in the corresponding thread. User-interface element 306 identifies a subject of “Opportunity with Acme” and a participant of “Carolyn Lao” for messages in the corresponding thread.

Fourth, the attributes may include information related to the most recent communication in each thread. For example, the information may indicate that the latest email in the thread represented by user-interface element 302 was sent by “James Smith” on Jan. 12, 2018, the latest message in the thread represented by user-interface element 304 was sent by “Carolyn Lao” on Jan. 8, 2018, and the latest message in the thread represented by user-interface element 306 was sent by “Mae Norris” on Nov. 2, 2017. The information may also include a summary of the most recent communication in each thread, such as a certain number of words from the beginning of the most recent communication.

The right side of the user interface includes a list of user-interface elements 308-310 containing communications from the thread represented by user-interface element 304. The list may be displayed in response to a user action related to user-interface element 304. For example, the contents of the thread may be expanded to the right of user-interface elements 302-306 after the user clicks on user-interface element 304, enters a keyboard shortcut for selecting user-interface element 304, and/or otherwise selects user-interface element 304. The user may subsequently select a different user-interface element 302 or 306 to update the right side of the user interface with the contents of the corresponding thread.

User-interface element 308 includes a message from “Carolyn Lao” with the subject or title shown in user-interface element 304 (“Excellent Full-Time Opportunity”). User-interface element 310 includes a message from “Mae Norris” that is sent in response to communication 308. A user-interface element 312 between the two communications 308-310 indicates that the applicant expressed interest in an opportunity on Jan. 8, 2018. For example, user-interface element 312 may be displayed after analyzing the content and/or sentiment of the communication in user-interface element 310 and/or receiving an explicit indication of interest in the opportunity from the applicant (e.g., after the applicant clicks an “I'm interested” button that is shown below communication 308 in a separate user interface).

The user may use a set of user-interface elements 316-320 to perform a number of actions related to the thread represented by user-interface element 304. The user may use user-interface element 316 to compose a new message for inclusion in the thread. After the message is written, the user may select user-interface element 318 to send the message (e.g., to the applicant). For example, the user may use user-interface elements 316-318 to compose and transmit a response to the message in user-interface element 310.

The user may select user-interface element 320 to schedule an appointment with the applicant. For example, the user may click user-interface element 320 to access a scheduling assistant for scheduling a phone call, interview, and/or other type of appointment with the applicant.

The user interface of FIG. 3 additionally includes a user-interface element 332 containing a recruiting profile for the applicant. The recruiting profile includes professional attributes of the applicant, such as a name (“Mae Norris”), title (“Awesomest Account Manager,”) employer (“Freshing”), school (“California Institute of Technology”), location (“Greater Chicago Area”), number of connections in the online professional network (“345”), and email address (“maenorris2016@abc.com”).

Below user-interface element 332, the user interface includes additional user-interface elements 322-330 representing other modules of the recruiting tool. The user may click and/or select each user-interface element to access and/or use the corresponding modules. User-interface element 322 (“Profile”) may be selected to access more detailed profile attributes of the applicant, such as the applicant's work history, professional groups, skills, accomplishments, and/or recommendations. User-interface element 324 (“Requisition”) may be selected to view a list of job requisitions for which the applicant is considered. User-interface element 328 (“Feedback”) may be selected to access a module for obtaining feedback related to the applicant from other recruiters and/or moderators. User-interface element 330 (“Attachment”) may be selected to obtain attachments related to the applicant, such as a resume for the applicant.

User-interface element 326 (“Conversation”) is currently selected, causing the user interface to display user-interface elements 302-320. As a result, user-interface elements 302-320 for viewing and/or conducting communications with the applicant may be displayed within the context of the applicant's profile or identity within the recruiting tool.

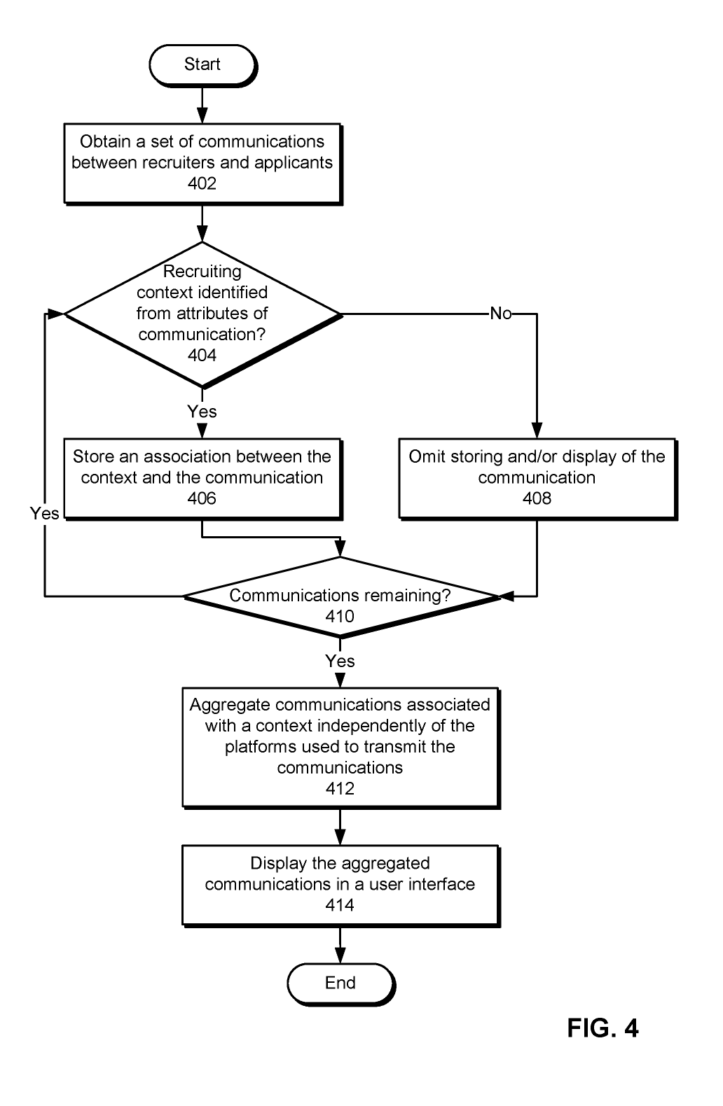

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a set of communications between recruiters and applicants is obtained (operation 402). For example, the communications may be imported from multiple platforms such as mail servers, cellular networks, chat services, videoconferencing systems, and/or social media services. As a result, the communications may include emails, SMS messages, voicemails, phone calls, video calls, and/or social media messages.

Next, a recruiting context may be identified from attributes of a communication (operation 404). The recruiting context may include participants of the communication that have roles in a recruiting or hiring process. For example, the recruiting context may identify an account (e.g., a subscription account) for accessing a recruiting tool, a recruiter, and/or an applicant for a job or opportunity.

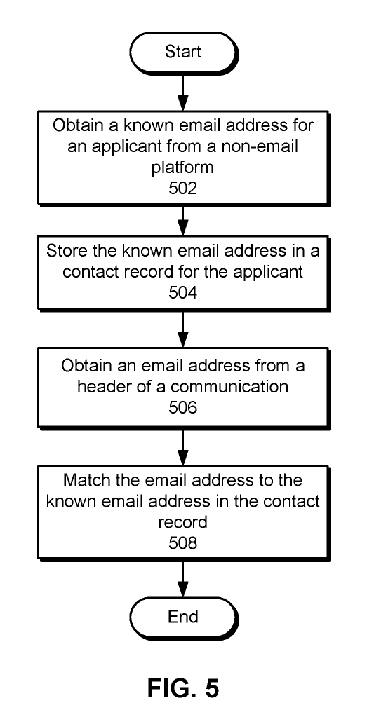

The attributes may include an email address, phone number, username, and/or other PII of one or more participants in the communication. To identify the recruiting context, the attributes may be matched to profile and/or contact information for the account, recruiter, and/or applicant. In addition, the attributes may include information that is not explicitly listed in the profile information by the respective users. For example, the attributes may include an email address that was obtained from a previous non-email communication with the applicant and stored in a contact record for the applicant, thus allowing the applicant to be automatically identified using the email address. Automatic identification of recruiting contexts associated with use of recruiting tools from attributes of communications is described in further detail below with respect to FIG. 5.

When the recruiting context is identified from the communication, an association between the context and the communication is stored (operation 406). For example, the association may include a record of the communication that references a record of the context and/or a record of the communication that is stored within a table or database representing the context.

When a recruiting context cannot be identified from attributes of the communication, storing and/or display of the communication is omitted (operation 408). For example, the communication may be deleted from a system into which the communication is imported and/or hidden from view within the system.

Operations 404-410 may be repeated for remaining communications (operation 410) obtained in operation 402. For example, each new email imported from an email account may be analyzed to determine a recruiting context or lack of recruiting context for the email. The email may then be processed based on the presence or absence of the recruiting context.

Communications associated with a given context are then aggregated independently of the platforms used to transmit the communications (operation 412). For example, the communications may be sorted, grouped, and/or otherwise organized by recruiting context and/or other attributes. Finally, the aggregated communications are displayed in a user interface (operation 414). For example, the aggregated communications may be shown as a list of threads and/or conversations within a user interface of an applicant tracking system and/or recruiting tool.

Within the user interface, the appearance of a communication may be adjusted based on a state represented by the communication. For example, the communication may be annotated and/or styled differently based on an applicant's interest in an opportunity, lack of interest in the opportunity, confirmation of a scheduled event, and/or a scheduling conflict with the event.

The user interface may also display or hide communications based on a visibility associated with each communication. For example, each communication and/or thread may have a visibility that is set to a specific recruiter, a hiring project associated with the applicant, and/or the account used to access a recruiting tool. As a result, a communication may be displayed to a user when the visibility includes the user.

The user interface may additionally display threads containing the aggregated communications based on additional attributes of the aggregated communications. For example, the user interface may sort, filter, group, and/or otherwise organize communications into threads based on attributes such as requisition, fields in a requisition, date, subject, recruiter, and/or applicant. The user interface may also, or instead, sort, filter, group, a and/or otherwise organize threads based on the same attributes and/or different attributes.

Finally, the user interface may display a recruiting profile of the applicant with the aggregated communications. For example, the user interface may include a link to and/or the content of a resume for the applicant, a professional attribute of the applicant (e.g., name, title, industry, seniority, work experience, educational background, skills, awards, publications, etc.), and/or a job for which the applicant is considered.

FIG. 5 shows a flowchart illustrating a process of automatically identifying a recruiting context from an attribute of a communication in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a known email address for an applicant is obtained from a non-email platform (operation 502). For example, the known email address may be obtained from a message thread between the applicant and a recruiter after the recruiter makes initial contact with the applicant through a messaging service provided by an online professional network. In another example, the known email address may be obtained from a personal website, company website, the applicant's member profile with the online professional network and/or another online community, and/or another publicly accessible record.

Next, the known email address is stored in a contact record for the applicant (operation 504). For example, the known email address may be added to a profile of the applicant with an online professional network. In another example, the known email address may be added to a “hire identity” for the applicant in an applicant tracking system and/or recruiting tool.

An email address is subsequently obtained from a header of a communication (operation 506) and matched to the known email address in the contact record (operation 508). For example, the communication may be an email with participants that include the applicant (e.g., using the known email address) and a recruiter that uses the recruiting tool. Because the known email address is already linked to the applicant in the contact record, the known email address may be used to establish a recruiting context for the email, as discussed above.

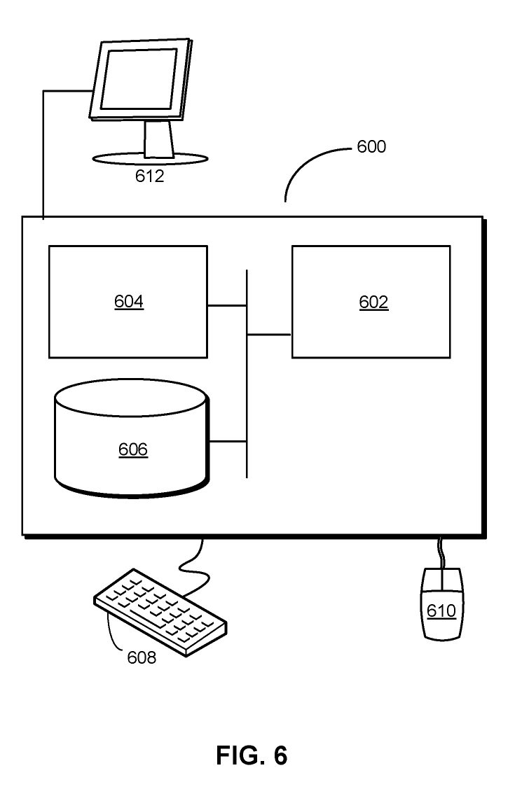

FIG. 6 shows a computer system 600 in accordance with the disclosed embodiments. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing data. The system includes a synchronization apparatus, an analysis apparatus, and a user interface, one or more of which may alternatively be termed or implemented as a module, mechanism, or other type of system component. The synchronization apparatus obtains, from multiple platforms, a set of communications between recruiters and applicants. Next, the analysis apparatus automatically identifies a recruiting context from one or more attributes of a first communication in the set of communications. The analysis also stores an association between the recruiting context and the first communication. The analysis apparatus then aggregates the first communication with additional communications associated with the recruiting context, independently of a set of platforms used to transmit the communications. Finally, the user interface displays the aggregated communications.

In addition, one or more components of computer system 600 may be remotely located and connected to the other components over a network. Portions of the present embodiments (e.g., synchronization apparatus, analysis apparatus, user interface, data repository, communication repository, online professional network, applicant tracking system, recruiting tool, etc.) may also be located on different nodes of a distributed system that implements the embodiments. For example, the present embodiments may be implemented using a cloud computing system that aggregates and displays recruiting-related communications from a set of remote platforms.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining, from multiple platforms, a set of communications between recruiters and applicants;
automatically identifying, by one or more computer systems, a recruiting context from one or more attributes of a first communication in the set of communications, wherein the recruiting context comprises an applicant associated with an opportunity;
storing an association between the recruiting context and the first communication;
aggregating, by the one or more computer systems, the first communication with additional communications associated with the recruiting context; and
displaying, within a user interface that is separate from a platform used to transmit the first communication, the aggregated first communication and the additional communications.

2. The method of claim 1, further comprising:
when a second communication cannot be matched to any recruiting contexts, omitting display of the second communication within the user interface.

3. The method of claim 1, further comprising:
displaying, with the aggregated first communication and the additional communications, a recruiting profile for the applicant.

4. The method of claim 3, wherein the recruiting profile comprises at least one of:
a professional attribute;
a job for which the applicant is considered; and
a resume.

5. The method of claim 1, wherein automatically identifying the recruiting context from the one or more attributes of the first communication comprises:
obtaining a known email address for the applicant from a non-email platform;
storing the known email address in a contact record for the applicant;
obtaining an email address from a header of the first communication; and
matching the email address to a known email address in a contact record for the applicant.

6. The method of claim 5, wherein the known email address is obtained from at least one of:
a member profile of the applicant with an online professional network; and
a messaging service provided by the online professional network.

7. The method of claim 1, wherein displaying the aggregated first communication and the additional communications within the user interface comprises:
adjusting an appearance of a communication in the user interface based on a state represented by the communication.

8. The method of claim 7, wherein the state comprises at least one of:
an interest in the opportunity;
a lack of interest in the opportunity;
a confirmation of an event; and
a scheduling conflict with the event.

9. The method of claim 1, wherein displaying the aggregated first communication and the additional communications within the user interface comprises:
including a communication in the user interface based on a visibility associated with the communication.

10. The method of claim 9, wherein the visibility is associated with at least one of:
a recruiter;
a requisition comprising the opportunity; and
the account.

11. The method of claim 1, wherein displaying the aggregated first communication and the additional communications within the user interface comprises:
displaying one or more threads comprising aggregated communications based on additional attributes of the aggregated communications.

12. The method of claim 11, wherein the additional attributes comprise at least one of:
a requisition comprising the opportunity;
a field of the requisition;
a date;
a subject;
a recruiter; and
the applicant.

13. The method of claim 1, wherein the set of communications comprises at least one of:
an email;
a Short Message Service (SMS) message;
a chat message;
a phone call;
a video call; and
a message transmitted within an online professional network.

14. The method of claim 13, wherein the user interface is provided by a recruiting tool.

15. A system, comprising:
one or more processors; and
memory storing instructions that, when executed by the one or more processors, cause the system to:
obtain, from multiple platforms, a set of communications between recruiters and applicants;
automatically identify a recruiting context from one or more attributes of a first communication in the set of communications, wherein the recruiting context comprises an applicant associated with an opportunity;
store an association between the recruiting context and the first communication;
aggregate the first communication with additional communications associated with the recruiting context; and
display, within a user interface that is separate from a platform used to transmit the first communication, the aggregated first communication and the additional communications.

16. The system of claim 15, wherein the memory further stores instructions that, when executed by the one or more processors, cause the system to:
when a second communication cannot be matched to any recruiting contexts, omit display of the second communication within the user interface.

17. The system of claim 15, wherein displaying the aggregated first communication and the additional communications within the user interface comprises:
adjusting an appearance of a communication in the user interface based on a state represented by the communication;
including another communication in the user interface based on a visibility of the other communication; and
displaying one or more threads comprising aggregated communications based on additional attributes of the aggregated communications.

18. The system of claim 17, wherein the visibility is associated with at least one of:
the recruiter;
a requisition comprising the opportunity; and
the account.

19. The system of claim 17, wherein the additional attributes comprise at least one of:
a requisition comprising the opportunity;
a field of the requisition;
a date;
a subject;
a recruiter; and
the applicant.

20. A non-transitory computer-readable storage medium storing instructions that when executed by a computer cause the computer to perform a method, the method comprising:
obtaining, from multiple platforms, a set of communications between recruiters and applicants;
automatically identifying a recruiting context from one or more attributes of a first communication in the set of communications, wherein the recruiting context comprises an applicant associated with an opportunity;
storing an association between the recruiting context and the first communication;
aggregating the first communication with additional communications associated with the recruiting context; and
displaying, within a user interface that is separate from a platform used to transmit the first communication, the aggregated first communication and the additional communications.
